(19) United States
(12) Patent Application Publication
(10) Pub. No.: US 2009/0016332 A1
(43) Pub. Date: Jan. 15, 2009

(54) Parallel computer system

(75) Inventors: Hidetaka Aoki, Tokyo (JP); Yoshiko Nagasaka, Kokubunji (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/010,687

(22) Filed: Jan. 29, 2008

(30) Foreign Application Priority Data
Jul. 13, 2007 (JP) 2007-184367

(51) Int. Cl. H04L 12/50

(52) U.S. Cl. 370/388

(57) ABSTRACT

To exchange data between adjacent nodes at high speed while using an existing network including a fat tree and a multistage crossbar switch. This invention provides a parallel computer system including: a plurality of nodes each of which includes a processor and a communication unit; a switch for connecting the plurality of nodes with each other; a first network for connecting each of the plurality of nodes and the switch; and a second network for partially connecting the plurality of nodes with each other. Further, the first network is comprised of one of a fat tree and a multistage crossbar network. Further, the second network partially connects predetermined nodes among the plurality of nodes directly with each other.

### CLAIM OF PRIORITY

The present application claims priority from Japanese application P2007-184367 filed on Jul. 13, 2007, the content of which is hereby incorporated by reference into this application.

### BACKGROUND OF THE INVENTION

This invention relates to a parallel computer system including a plurality of processors, in particular, a system and an architecture of a supercomputer.

In a parallel computer provided with a plurality of nodes including a processor, the nodes are connected with each other by a tree topology network such as a fat tree, by a multistage crossbar switch, and by other such means, and a computation processing is executed while communications such as data transfers between the nodes are performed. Particularly in a parallel computer such as a supercomputer including a large number of (for example, 1,000 or more) nodes, the fat tree and the multistage crossbar switch are used, the area of the parallel computer is divided into a plurality of computer areas, which are allocated to a plurality of users, thereby improving the utilization efficiency of the whole computer. In addition, the fat tree allows connections between distant nodes on a one-to-one basis, which makes it possible to perform a communication at high speed. However, the fat tree has a problem in that it is more difficult to exchange data between adjacent nodes at high speed than a 3-dimensional torus, which will be described below.

The parallel computer such as a supercomputer is generally used for simulations of natural phenomena. Many applications for such simulations, which set a simulation area as a 3-dimensional space, generally use a network such as a 3-dimensional torus in which the calculation area of the parallel computer is divided into 3-dimensional rectangular areas, and in which nodes that are adjacent within a 3-dimensional space (computational space) are connected with each other. In the 3-dimensional torus, the adjacent nodes are connected directly, so data can be exchanged between adjacent calculation areas at high speed. This allows a high speed data exchange between adjacent calculation areas, which often occurs in a 3-dimensional space computation during a simulation of a natural phenomenon.

For a large scale parallel computer such as a supercomputer, there is known a technology that combines a tree topology network (global tree) and a torus (for example, JP 2004-538548 A).

### SUMMARY OF THE INVENTION

Generally employed in the parallel computer such as a supercomputer including a large number of (for example, several thousand) nodes is a technique of dividing the area of the parallel computer into a plurality of computer areas to improve the utilization efficiency and executing an application of each of different users in each computer area. Therefore, in the parallel computer such as a supercomputer, it is desirable that a computer area can be easily divided as in a fat tree, and that data be exchanged between adjacent nodes at high speed as in a torus.

However, the above-mentioned case using a fat tree has a problem in that the parallel computer including a large number of nodes as described above, which aims at exchanging data between adjacent nodes at high speed on all of the nodes as in a torus connection, is difficult to realize because a huge multistage crossbar switch is necessary, requiring enormous spending on equipment.

The case of JP 2004-538548 A, in which nodes are connected by two independent networks of a global tree and a 3-dimensional torus, has a problem in that data cannot be exchanged between adjacent nodes at high speed by using the global tree, which is used for a one-to-one or one-to-many aggregate communication.

Therefore, this invention has been made in view of the above-mentioned problems, and an object thereof is to perform data exchanges between adjacent nodes at high speed while using an existing network including a fat tree and a multistage crossbar switch.

According to this invention, a parallel computer system includes: a plurality of nodes each of which includes a processor and a communication unit; a switch for connecting the plurality of nodes with each other; a first network for connecting each of the plurality of nodes and the switch; and a second network for partially connecting the plurality of nodes with each other.

Further, the first network is comprised of one of a fat tree and a multistage crossbar network.

Further, the second network partially connects predetermined nodes among the plurality of nodes directly with each other.

According to this invention, data can be exchanged between adjacent nodes at high speed while an existing first network including a fat tree and a multistage crossbar switch, is used with only a second network added thereto. Particularly in a case of performing a computation in a multidimensional rectangular area, it is possible to exchange data between adjacent nodes at higher speed than in the case of using the existing fat tree and multistage crossbar switch. Accordingly, by using the existing first network, it is possible to build a parallel computer system with high performance at low cost.

### BRIEF DESCRIPTION OF THE DRAWINGS

FIG. 1 is a block diagram of a parallel computer system including a 3-stage fat tree, to which this invention is applied.

FIG. 2 is a block diagram showing a configuration of a node and a network NW0.

FIG. 3 is a block diagram showing a configuration of a node.

FIG. 4 is an explanatory diagram showing an example format of a packet transmitted/received by a node.

FIG. 5 is a block diagram showing a structure of a conventional 3-dimensional torus.

FIG. 6 is a block diagram showing a configuration of the node of the 3-dimensional torus and a network.

FIG. 7 is an explanatory diagram showing an example of a user program (source code) for performing one-dimensional data transfers between adjacent nodes.

FIG. 8 is an explanatory diagram showing a flow of data exchanged between adjacent nodes in an X-axis network of the 3-dimensional torus shown in FIG. 5.

FIG. 9 is an explanatory diagram showing a flow of data exchanged between adjacent nodes in the fat tree shown in FIG. 1.

FIG. 10 is a block diagram of a parallel computer system showing a configuration of one leaf switch and nodes of the fat tree shown in FIG. 1, according to a first embodiment of this invention.

FIG. 11 is a block diagram showing a configuration of a node according to the first embodiment of this invention.

FIG. 12 is an explanatory diagram showing a flow of data exchanged between adjacent nodes according to the first embodiment of this invention.

FIG. 13 is an explanatory diagram showing a flow of data exchanged between an odd number of adjacent nodes according to the first embodiment of this invention.

FIG. 14 is an explanatory diagram showing a 3-dimensional rectangular area composed of 4 nodes in each axis, and indicating a process ID of each of the nodes on each of which a predetermined application is executed.

FIG. 15 is an explanatory diagram showing an example of a user program (source code) for performing 3-dimensional data transfers between adjacent nodes.

FIG. 16 is an explanatory diagram showing a 3-dimensional rectangular area composed of 4 nodes in each axis, and indicating a node ID of each of the nodes.

FIG. 17 is a block diagram showing a configuration of a node of the 3-dimensional torus.

FIG. 18 is an explanatory diagram showing a connection relationship between leaf switches A to P and the node IDs.

FIG. 19 is an explanatory diagram showing an example of performing data transfers by the leaf switch A in the 3-stage fat tree in an X-axis direction.

FIG. 20 is an explanatory diagram showing an example of performing data transfers in the 3-stage fat tree in a Y-axis direction.

FIG. 21 is an explanatory diagram showing an example of performing data transfers in the 3-stage fat tree in a Z-axis direction.

FIG. 22 is a block diagram showing connections between nodes according to a second embodiment of this invention.

FIG. 23 is a block diagram showing an example of a 3-stage fat tree and partial networks according to the second embodiment of this invention.

FIGS. 24A to 24D are block diagrams showing connections between nodes and with the leaf switches according to the second embodiment of this invention, in which FIG. 24A indicates connection relationships around a node whose node ID is 000, FIG. 24B indicates connection relationships around a node whose node ID is 200, FIG. 24C indicates connection relationships around a node whose node ID is 020, and FIG. 24D indicates connection relationships around a node whose node ID is 220.

FIG. 25 is a block diagram showing a node according to the second embodiment of this invention.

FIG. 26 is an explanatory diagram showing connection relationships between nodes in a group of the leaf switches in a Y-axis direction and a Z-axis direction according to the second embodiment of this invention.

FIG. 27 is an explanatory diagram showing a flow of data exchanged between adjacent nodes in an X-axis direction according to the second embodiment of this invention.

FIG. 28 is an explanatory diagram showing a flow of data exchanged between adjacent nodes in a Y-axis direction according to the second embodiment of this invention.

FIG. 29 is an explanatory diagram showing a flow of data exchanged between adjacent nodes in a Z-axis direction according to the second embodiment of this invention.

FIG. 30 is a block diagram showing connections between nodes according to a third embodiment of this invention.

FIG. 31 is a block diagram showing an example of a 2-stage fat tree and partial networks according to a fourth embodiment of this invention.

FIG. 32 is an explanatory diagram showing connection relationships between the leaf switches in the 2-stage fat tree and nodes according to the fourth embodiment of this invention.

### DETAILED DESCRIPTION OF THE PREFERRED EMBODIMENTS

Hereinafter, description will be made of embodiments of this invention with reference to the attached drawings.

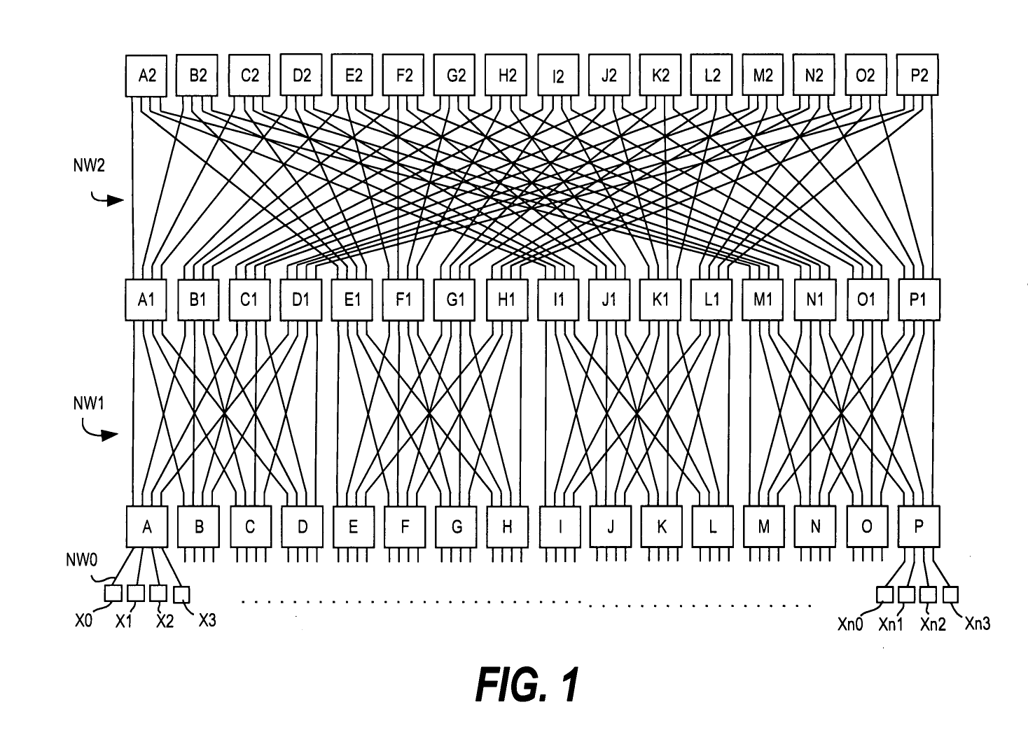

FIG. 1 is a block diagram of a parallel computer system including a 3-stage fat tree, to which this invention is applied.

FIG. 1 shows an example of forming a fat tree by a 3-layer (3-stage) crossbar switch group. Each of crossbar switches (hereinafter, referred to as “leaf switches”) A to P on a lowermost layer (first stage) is connected with 4 nodes X via a point-to-point network NW0. It should be noted that in the following description, a generally-described node is referred to simply as “node”, while a node to be identified is denoted by X added with 0 to 3, n0 to n3, or the like.

In FIG. 1, a leaf switch A includes 4 ports for connection with the nodes X0 to X3 and 4 ports for connection with a crossbar switch group on a middle layer (second stage). It should be noted that the other leaf switches have a similar structure. In this case, in the parallel computer system of FIG. 1, 4 nodes are connected with each of the leaf switches A to P, and 4 leaf switches A to D (E to H, I to L, and M to P) constitute one node group, which is thus composed of 16 nodes.

The leaf switch A is connected with crossbar switches A1 to D1 on the second stage via a network NW1, while each of the leaf switches B to D is similarly connected with the crossbar switches A1 to D1 on the second stage.

To perform communications between the nodes connected with the leaf switches A to D, the communications are performed via the leaf switch A to D and the crossbar switch A to D on the second stage. For example, when the node X0 connected with the leaf switch A communicates with a node (not shown) connected with the leaf switch D, the communication is performed via the leaf switch A, the crossbar switch A1 on the second stage, and the leaf switch D.

Crossbar switches A1 to P1 on the second stage are connected with crossbar switches A2 to P2 on an uppermost layer (third stage) via a network NW2. In FIG. 1, the crossbar switch A1 on the second stage is connected with the crossbar switches A2 to D2 on the third stage, the crossbar switch B1 on the second stage is connected with the crossbar switches E2 to H2 on the third stage, the crossbar switch C1 on the middle stage is connected with the crossbar switches I2 to L2 on the third stage, and the crossbar switch D1 on the second stage is connected with the crossbar switches M2 to P2 on the third stage. The crossbar switches A1 to D1 on the second stage comprising one node group are connected with all of the crossbar switches A2 to P2 on the third stage. The crossbar switches E1 to P1 on the second stage in the other node groups (E to H, I to L, and M to P) are also connected with all of the crossbar switches A2 to P2 on the third stage similarly on a node group basis.

When a given node communicates with another node in a node group other than the node group to which the given node belongs, the communication is performed via the crossbar switches A2 to P2 on the third stage. For example, when the node X0 connected with the leaf switch A communicates with the node Xn0 connected with the leaf switch P, the communication is performed via the leaf switch A, the crossbar switch A1 on the second stage, the crossbar switch D2 on the third stage, the crossbar switch M1 on the second stage, and the leaf switch P.

As described above, all of the nodes can communicate directly with one another in the fat tree.

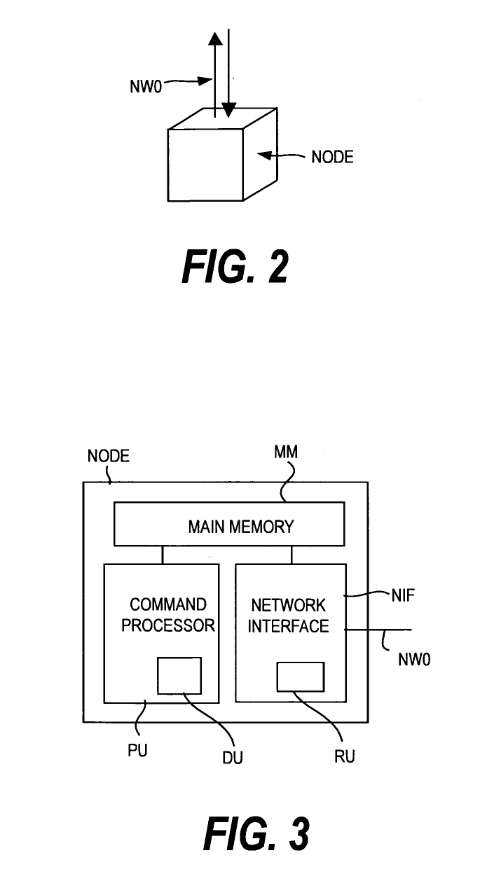

FIG. 2 shows a configuration of a node and the network NW0, in which the node is connected with the leaf switch through one link (network NW0), and two-way (uplink/downlink) communications are performed simultaneously. Any networks that allow the two-way communications can be used as the networks NW0 to NW2, and the networks may be comprised of, for example, InfiniBand or the like.

FIG. 3 is a block diagram showing a configuration of the node shown in FIG. 1.

The node includes a processor PU for performing a computation processing, a main memory MM for storing data and a program, and a network interface NIF for performing two-way communications with the network NW0. The network interface NIF is connected with the network NW0 via a single port to transmit/receive data in the form of packet. The network interface NIF includes a routing unit RU for controlling a route for a packet. The routing unit RU contains a table in which a configuration of node groups, identifiers of nodes, and the like are stored, and controls a transmission destination of the packet.

The processor PU is configured by including a processor core, a cache memory, and the like, and implements a communication packet generation unit DU for generating a packet for performing a communication with another node. The communication packet generation unit DU may be implemented by a program stored in the main memory MM, the cache memory, or the like, or may be implemented by including hardware such as the network interface NIF. It should be noted that the main memory MM is provided to each node in this embodiment, but may be a shared memory or distributed shared memory that are shared with another node.

The processor PU further implements a user program and an OS that are stored in the main memory MM, and communicates with another node as necessary.

The processor PU may be comprised of a single core or a multiple core, and the processor PU of the multiple core can have a homogeneous structure and a heterogeneous structure.

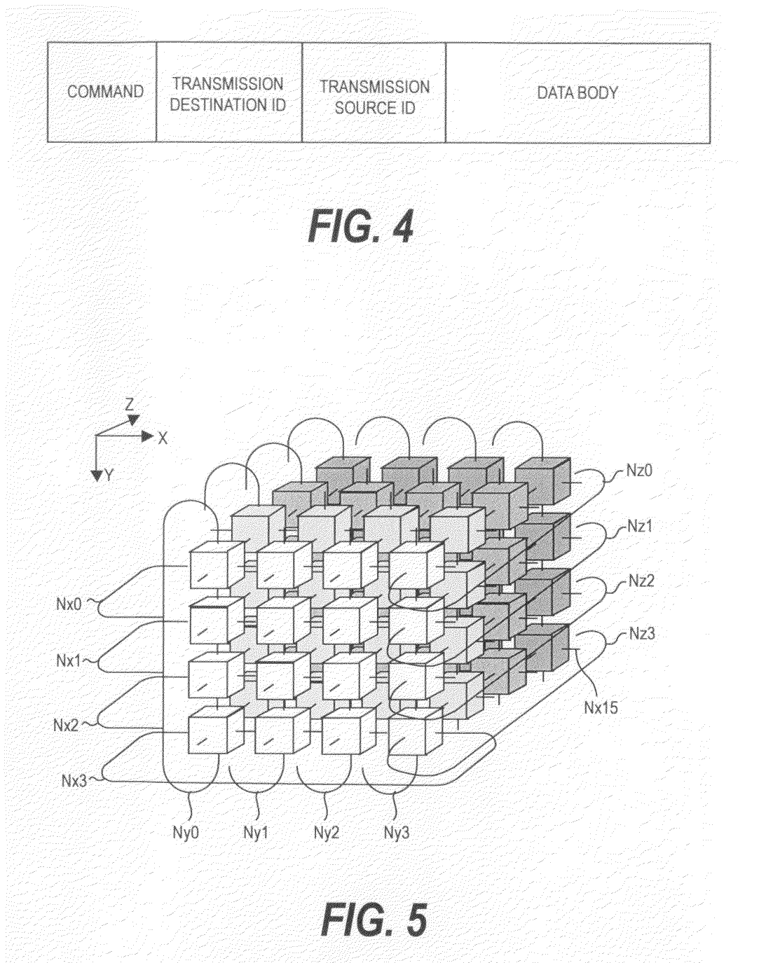

FIG. 4 is an explanatory diagram showing an example format of a packet transmitted/received by a node. The packet has a command at the head thereof, a transmission destination ID indicating the identifier of a transmission destination node, a transmission source ID indicating the identifier of a transmission source node, and a data body.

FIG. 5 is a block diagram showing a structure of a conventional 3-dimensional torus, and shows an example of 64 nodes in which 4 nodes are provided in each of directions of the X-, Y-, and Z-axes of a computation space. The 3-dimensionally-connected processors form a plurality of ring networks in each of the X-, Y-, and Z-axis directions. For the X-axis direction, 4 nodes are connected to form each of networks Nx0 to Nx15 in the X-axis direction. Similarly, for the Y-axis direction, 4 nodes are connected to form each of networks Ny0 to Ny15 in the Y-axis direction, and for the Z-axis direction, 4 nodes are connected to form each of networks Nz0 to Nz15 in the Z-axis direction.

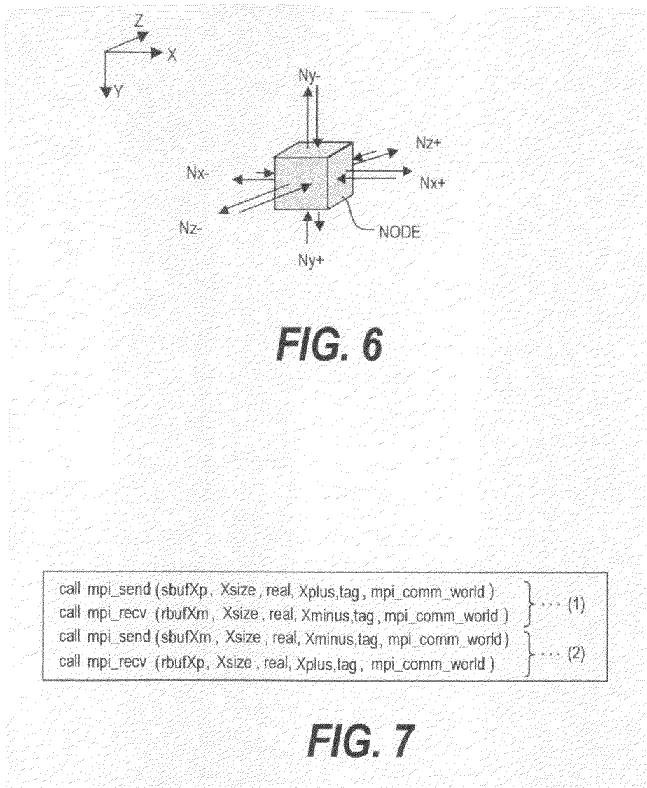

As shown in FIG. 6, the networks Nx, Ny, and Nz formed along the respective axes to connect the nodes allow communications to be performed in 2 directions (“+” direction and “−” direction) along each of the respective axes (networks Nx to Nz), which means that a given node in a torus connection is connected with adjacent nodes in 6 directions.

FIG. 7 shows an example of a user program (source code) for performing one-dimensional data transfers between adjacent nodes. The source code (1) of FIG. 7 indicates that in the case of the X-axis shown in FIG. 6, an “mpi_send” command transmits data toward “Xplus” (Nx+ direction in FIG. 6) while an “mpi_recv” command receives data from “Xminus” (Nx− direction in FIG. 6). It should be noted that in actuality, the processor PU substitutes the identifiers or addresses of adjacent nodes into “Xplus” and “Xminus”, and creates a packet shown in FIG. 4. The execution of the source code (1) of the user program allows a data transfer toward the Nx+ direction in FIG. 6.

Subsequently, the source code (2) of FIG. 7 indicates that in the case of the X-axis shown in FIG. 6, the “mpi_send” command transmits data toward “Xminus” (Nx− direction in FIG. 6) while the “mpi_recv” command receives data from “Xplus” (Nx+ direction in FIG. 6). The execution of the source code (2) of the user program allows a data transfer toward the Nx− direction in FIG. 6.

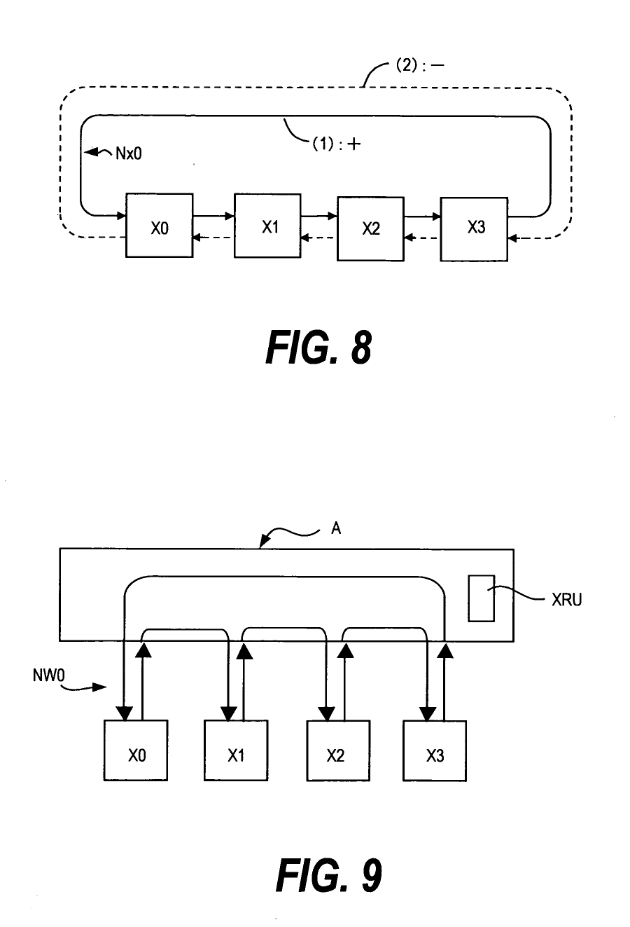

FIG. 8 shows the X-axis network Nx0 within the 3-dimensional torus shown in FIG. 5, showing an example where the above-mentioned user program of FIG. 7 is executed on each of the connected 4 nodes X0 to X3.

The 4 nodes X0 to X3 connected in a torus form the network Nx0 that allows the two-way communications, and can therefore execute a data transfer toward a positive direction indicated by the source code (1) of FIG. 7 and a data transfer toward a negative direction indicated by the source code (2) of FIG. 7 simultaneously. In other words, in the case of the torus, one node has two connections of the “−” direction and the “+” direction along one axis direction. Therefore, by simultaneously performing the data transfer (circulation) toward the positive direction and the data transfer (circulation) toward the negative direction, it is possible to perform data exchanges within adjacent areas in the user program for a simulation of a natural phenomenon in the minimum period of time.

FIG. 9 shows an example where the above-mentioned user program of FIG. 7 is executed on the 4 nodes X0 to X3 connected with the leaf switch A within the fat tree shown in FIG. 1. It should be noted that each crossbar switch includes a routing unit XRU for transmitting/receiving a packet by using the shortest route.

For the 4 nodes X0 to X3 connected by the leaf switch A and the network NW0, the network NW0 allows the two-way communications. In this case, the node within the fat tree has only one connection with the leaf switch A, so communication processings that can be executed simultaneously are transmission of one connection and reception of one connection.

Therefore, when the data transfer toward the positive direction indicated by the source code (1) of FIG. 7 is executed on the nodes X0 to X3 connected with the leaf switch A, the network NW0 that connects the nodes with the leaf switch A is occupied by the data transfers toward the positive direction between adjacent nodes. Accordingly, the simultaneous data transfer toward the negative direction indicated by the source code (2) of FIG. 7 cannot be executed on each of the nodes X0 to X3. In other words, the data transfer toward the negative direction indicated by the source code (2) of FIG. 7 is executed after the data transfer toward the positive direction indicated by the source code (1) of FIG. 7 has been completed. This implies that the data exchanges between the adjacent nodes within the fat tree require a time twice as long as that in the case of the 3-dimensional torus shown in FIG. 8.

In the fat tree, all of the nodes can communicate with each other on a one-to-one basis, and the structure of node groups can be changed with ease, so a plurality of computer areas can be allocated to a plurality of users for effective use of computer resources. However, the fat tree has characteristics that are not suitable for such an application as to be used for a simulation of a natural phenomenon in which data is exchanged between adjacent nodes.

### First Embodiment

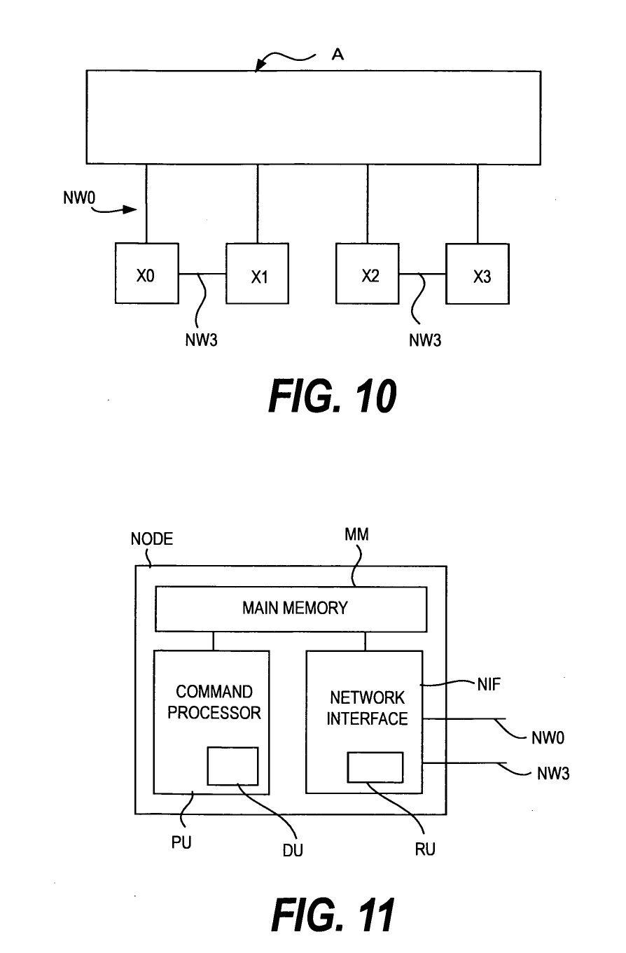

FIG. 10 is a block diagram of a parallel computer system according to a first embodiment of this invention, in which the leaf switch A and the 4 nodes X0 to X3 of the fat tree shown in FIG. 1 are partially changed.

The nodes X0 to X3 are connected with each other by the network NW0 that allows the two-way communications similarly to those of FIG. 1. Adjacent 2 nodes form a pair, and there is provided a partial network NW3 for directly connecting only the nodes forming each pair. It should be noted that each node belongs to only one pair, and does not belong to another pair simultaneously.

In the example of FIG. 10, the nodes X0 and X1 form a pair, and the nodes X2 and X3 form another pair. The nodes X0 and X1 forming the pair are directly connected with each other by the partial network NW3, while the nodes X2 and X3 forming the pair are directly connected with each other by the partial network NW3. In this case, the nodes X1 and X2 are the adjacent nodes, but one node does not allowed to belong to a plurality of pairs, so the connection relationship between the nodes X1 and X2 is the same as that of FIG. 1. The nodes connected with each of the other leaf switches B to P shown in FIG. 1 similarly form pairs, and the nodes of each pair are directly connected with each other by the partial network NW3. It should be noted that the partial network NW3 can be comprised of InfiniBand or the like similarly to the other networks.

FIG. 11 is a block diagram showing a configuration of each of the nodes shown in FIG. 10. The configuration of the node of FIG. 11 is the same as that described above in FIG. 3 except that in FIG. 11, the same network interface NIF as that of the node shown in FIG. 3 is provided with the partial network NW3 for directly connecting the nodes forming a pair. The routing unit RU references the ID of a packet transmission destination node to send out the packet to the partial network NW3 if the node is directly connected with the transmission destination node, and otherwise send out the packet to the network NW0.

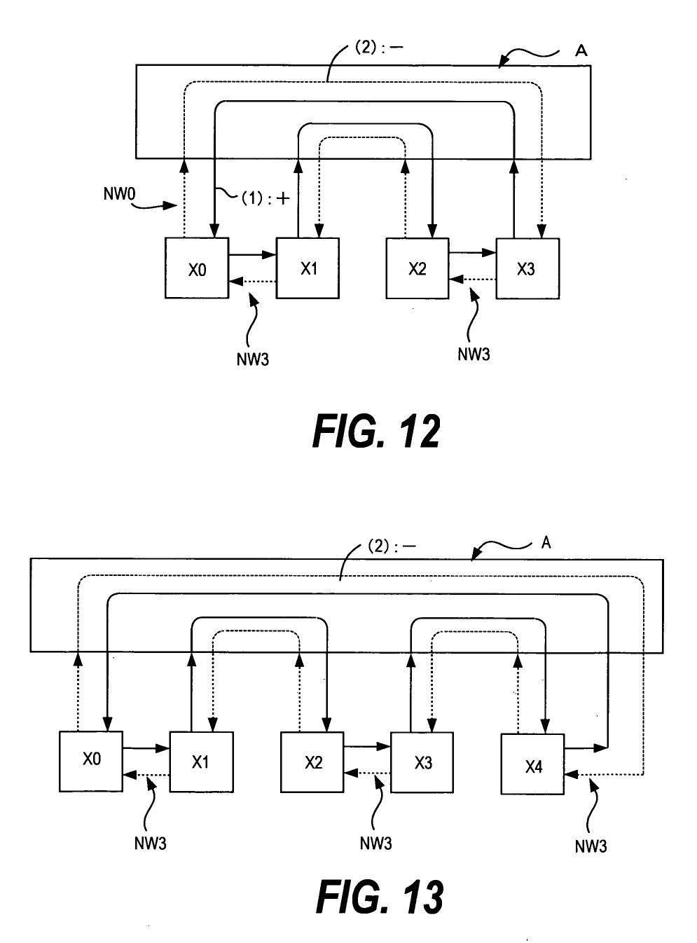

FIG. 12 shows an example where the user program for data exchanges indicated above in FIG. 7 is executed on the nodes X0 to X3 shown in FIG. 10.

The 4 nodes X0 to X3 connected with the leaf switch A are each directly connected with the other node of the same pair by the partial network NW3, and can each perform the two-way communications with a node of the different pair via the network NW0 and the leaf switch A. To be specific, the nodes X0 and X1 forming a pair perform the two-way communications by the partial network NW3, and the nodes X2 and X3 forming another pair similarly perform the two-way communications by the partial network NW3. The nodes X1 and X2 each belonging to the adjacent different pairs perform the two-way communications by the network NW0 and the leaf switch A, and the nodes X0 and X3, which are located at both ends of the leaf switch A and belong to the different pairs, similarly perform the two-way communications by the network NW0 and the leaf switch A.

Therefore, the data transfer toward the positive direction indicated by the source code (1) of FIG. 7 and the data transfer toward the negative direction indicated by the source code (2) of FIG. 7 can be executed simultaneously on each of the nodes X0 to X3. In other words, as in the one-dimensional torus connection shown in FIG. 8, the data exchanges can be executed simultaneously toward the positive direction and the negative direction, which allows the data exchanges to be performed within adjacent areas in the user program for a simulation of a natural phenomenon in the minimum period of time.

In other words, according to this invention, only adding the partial network NW3 (partial network) within each pair to the network configuration composed of the fat tree and the multistage crossbar switch, it is possible to secure a transfer capability twice as high as the transfer capability exerted by the existing leaf switch A and the nodes X0 to X3 shown in FIG. 9.

Therefore, according to the first embodiment, only by adding a partial network for directly connecting nodes forming each pair while using the existing network including the fat tree and the multistage crossbar switch, it is possible to double the communication amount (bandwidth) between adjacent nodes, and perform data exchanges between the adjacent nodes at high speed as in the torus. Accordingly, it is possible to build a high performance parallel computer system while suppressing equipment spending. In addition, in the parallel computer system according to the first embodiment, it is possible to enjoy the ease of dividing a computer area, which is exhibited by the fat tree or the like, and the high speed in the data exchanges between adjacent nodes, which is exhibited by the torus. Accordingly, it is possible to provide a parallel computer system or a supercomputer, which is excellent in both the utilization efficiency and the computation performance, at low cost.

It should be noted that the number of nodes connected with the leaf switch A is set as 4 in the first embodiment, but in the case of an odd number of nodes, there may be a node that cannot form a pair. Thus, as shown in FIG. 13, a node X4 that cannot form a pair is also provided with the partial network NW3, and the partial network NW3 is connected with the leaf switch A. Accordingly, even in the case of the odd number of nodes, it is possible to simultaneously perform the data exchanges toward the positive direction and the negative direction.

In the configuration of FIG. 10, all of the nodes are connected with the fat tree as well, but it is clear that the same adjacent transfer capability as described above can be realized even if there is a node that is not connected with the fat tree inbetween.

### Second Embodiment

Hereinafter, a second embodiment of this invention will be described by applying the first embodiment of this invention to data transfers between adjacent nodes within a 3-dimensional rectangular area. The second embodiment of this invention will be described below after examples of the fat tree and the 3-dimensional torus to be used for comparison with the second embodiment.

(3-Dimensional Rectangular Area)

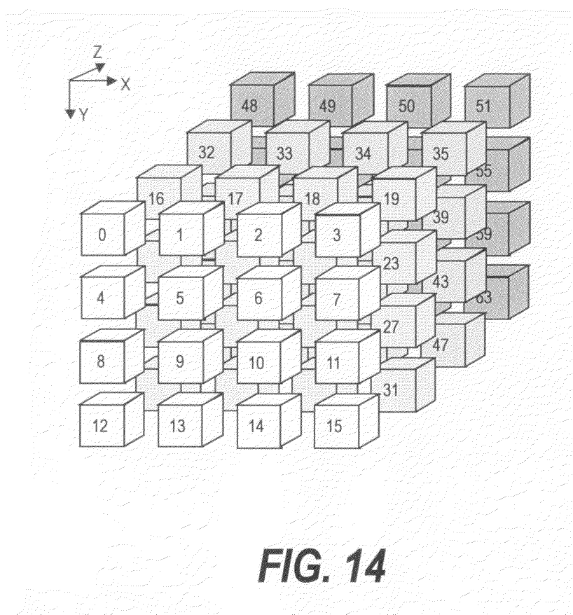

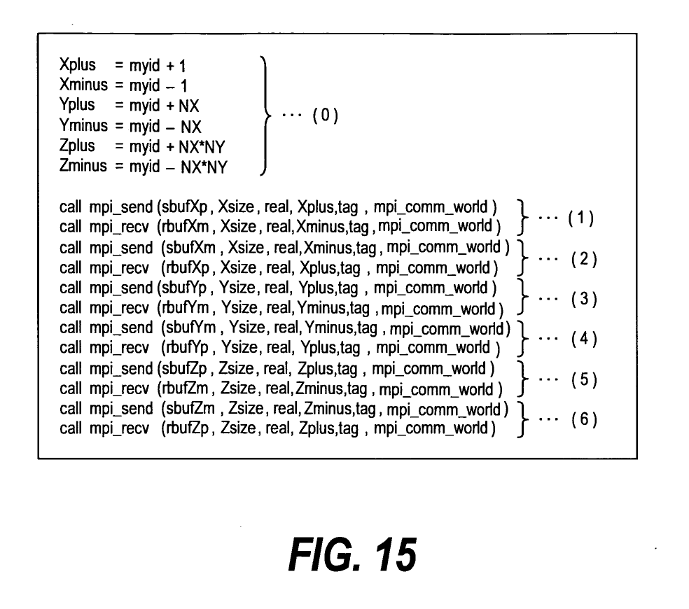

FIG. 14 shows a 3-dimensional rectangular area composed of 4 nodes in each axis similarly to the 3-dimensional torus shown in FIG. 5, and indicates a process ID of each of the nodes on each of which a predetermined application is executed. FIG. 14 shows an example where the process ID of the application increases in order from the X-axis to the Y-axis to the Z-axis of the 3-dimensional rectangular area, and in the example of FIG. 14, 0 to 63 are mapped to the process IDs. In data exchanges between adjacent nodes within the 3-dimensional rectangular area, a program (application) for performing data exchanges between adjacent nodes along the X-axis direction, the Y-axis direction, and the Z-axis direction of FIG. 14 based on the process IDs is executed on each node. An example of the program is shown in FIG. 15.

The source code (0) of FIG. 15 determines the ID of a data transfer destination in each of the X-, Y-, and Z-directions, with the portions “plus” and “minus” of FIG. 15 representing the positive direction and the negative direction, respectively. The portion “myid” represents the process ID of the own node, the portion “NX” represents the number of nodes located along the X-axis direction, and the portion “NY” represents the number of nodes located along the Y-axis direction, so NX=NY=4 in the case of FIG. 14.

The source codes (1) to (6) of FIG. 15 indicates a program for performing data transfers toward the positive direction and the negative direction between nodes adjacent to each other in each of the X-, Y-, and Z-directions by the “mpi_send” command and “mpi_recv” command shown in FIG. 7.

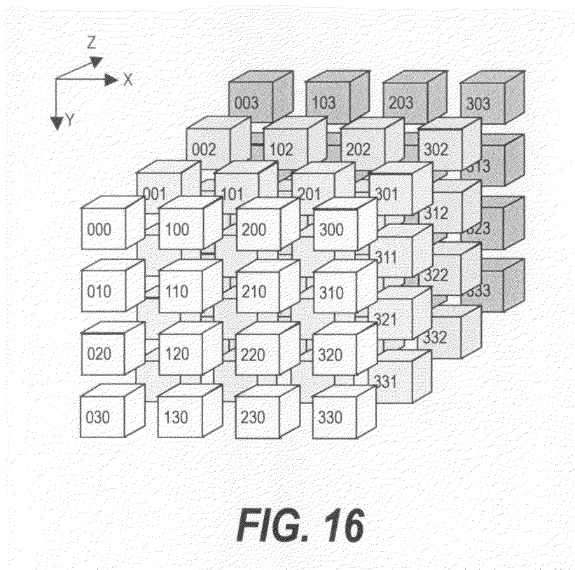

At the same time, node IDs are preset for each of the nodes as shown in FIG. 16. FIG. 16 shows an example where the node ID is expressed in a 3-digit number. The third digit (hundred's digit) of the node ID is serialized in the X-axis direction, and increases from 0 to 3 from the left to right of FIG. 16. The second digit (ten's digit) of the node ID is serialized in the Y-axis direction, and increases from 0 to 3 from the top to bottom of FIG. 16. The first digit (one's digit) of the node ID is serialized in the Z-axis direction, and increases from 0 to 3 from the front to back of FIG. 16.

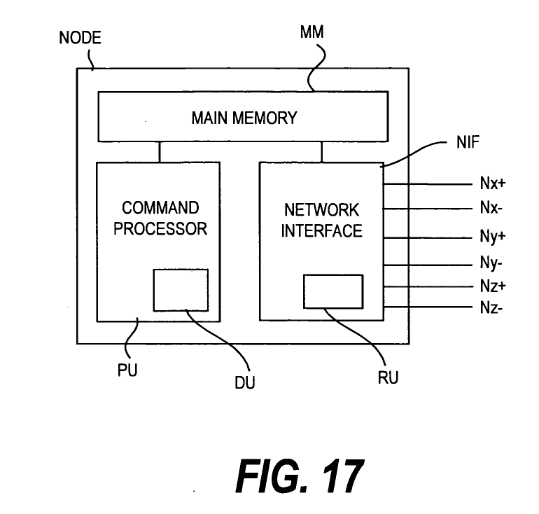

FIG. 17 is a block diagram showing a configuration of each node of the 3-dimensional torus. The configuration of the node is the same as that of the first embodiment shown in FIG. 3, and the communication packet generation unit DU associates the process IDs with the node IDs. To this end, each of the nodes has a table in which the association between the process IDs and the node IDs is defined in advance.

It should be noted that the network interface NIF of FIG. 17 has links (network connections) toward 6 directions Nx+, Nx−, Ny+, Ny−, Nz+, and Nz−.

On each of the nodes, the program shown in FIG. 15 is executed to perform data transfers in the directions along the respective axes. For example, when the node having the process ID “1” in FIG. 14 (having the node ID “100” in FIG. 16) executes the “mpi_send” command of the source code (3) of FIG. 15, the process ID of the transmission destination is expressed as follows.

Yplus=1+4

Thus, the node having the process ID “5” in FIG. 14 becomes the data transmission destination. The communication packet generation unit DU of the node having the process ID “1” acquires the node ID “110” of the transfer destination as shown in FIG. 16 from a predetermined table, and generates a packet by setting the own node ID “100” and the node ID “110” in the transmission source ID field and the transmission destination ID field of the packet shown in FIG. 4, respectively, and containing a predetermined data body. Then, the network interface NIF transmits the packet to the node having the node ID “110”.

### (3-Dimensional Torus)

Next, description will be made of an example where such data exchanges between adjacent nodes within the 3-dimensional rectangular area as described above with reference to FIGS. 14 to 16 are performed in the 3-dimensional torus shown in FIG. 5.

In the networks Nx0 to Nx3, Ny0 to Ny3, and Nz0 to Nz3 formed along the respective axis directions as shown in FIG. 5, the nodes are connected with each other in the ascending order of the serial node IDs shown in FIG. 16. For example, the network Nx0 connects the nodes having the node IDs “000”, “100”, “200”, and “300”. In other words, in the networks Nx0 to Nx3 along the X-axis direction, the nodes having the node IDs whose first digits (increasing along the Z-axis) and second digits (increasing along the Y-axis) are the same are connected in the ascending order of the third digits of the node IDs, which increase in the X-axis direction. The same applies to the networks Ny and Nz formed along the Y-axis direction and the Z-axis direction, respectively.

In the 3-dimensional torus, the data transfers toward the positive direction and the negative direction can be executed simultaneously in the respective axis directions as shown in FIG. 8, and a time required for the data exchange between adjacent nodes in the 3-dimensional torus is set as “1T”.

### (3-Stage Fat Tree)

Next, description will be made of an example where the 3-dimensional rectangular area shown in FIGS. 14 and 16 is realized by the 3-stage fat tree shown in FIG. 1.

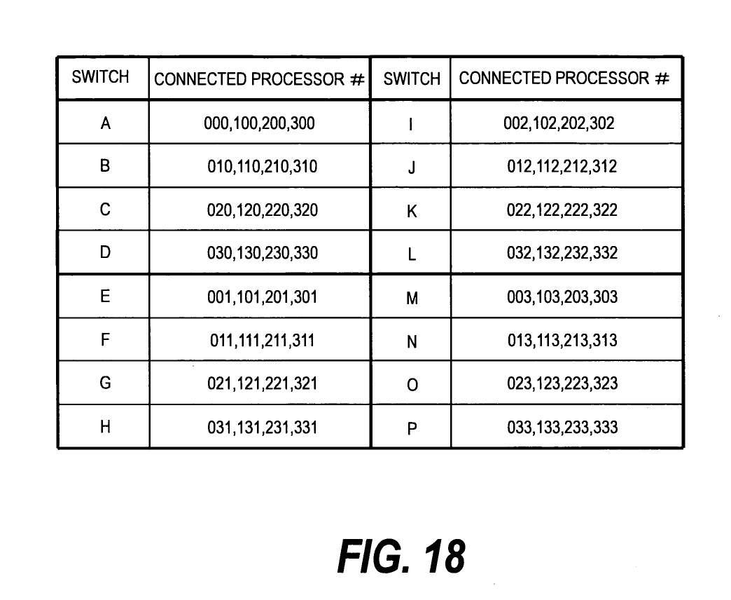

In order to connect nodes as shown in FIGS. 14 and 16 in the directions along the respective axes X, Y, and Z within the fat tree shown in FIG. 1, a relationship between the node IDs of FIG. 16 of the nodes connected with the leaf switches A to P of FIG. 1 is set as shown in FIG. 18, for example.

The mapping of the nodes with respect to the leaf switches shown in FIG. 18 is performed as follows. It should be noted that a mapping operation is performed by an administrator of the parallel computer system or the like.

First, nodes of FIG. 16 that have the node IDs whose third digits are serialized in the X-axis direction are all connected with the same leaf switch. To be specific, nodes that have the node IDs whose first and second digits respectively have the same values and whose third digits are different are all connected with the same leaf switch. Those nodes can communicate with each other by one of the leaf switches A to P on the first switch stage. For example, the leaf switch A is connected with the nodes having the node IDs “000”, “100”, “200”, and “300” whose first and second digits are “00” and whose third digits are serialized.

Subsequently, the leaf switches A to P are classified into groups in each of which leaf switches can communicate with each other on the second switch stage (by the crossbar switches A1 to P1). As is clearly shown in FIG. 1, the leaf switches A to D, E to H, I to L, and M to P respectively form a group. In the connections indicated in FIG. 18, a group of processors that are serialized in the Y-axis direction are allocated to the leaf switches within each group.

To be specific, the nodes having the node IDs whose second digits (increasing along the Y-axis direction) are serialized and whose first digits (increasing along the Z-axis) are the same are connected with each of the groups of the leaf switches A to D, E to H, I to L, and M to P. For example, the leaf switches A to D are connected with the nodes having such node IDs 000, 010, 020, and 030 as to have the second digits serialized. The same applies to the leaf switches of the other groups. Those processors can communicate with each other on the second switch stage. For example, the node with the node ID “000” connected with the leaf switch A and the node with the node ID “010” connected with the leaf switch B are communicably connected with each other via the crossbar switch A1, B1, C1, or D1 on the second switch stage. According to the connections shown in FIG. 18, the nodes having the node IDs serialized in the Z-axis direction, in other words, whose first digits are different can communicate with each other on the third switch stage. For example, such nodes serialized in the Z-axis direction as the node with the node ID “000” connected with the leaf switch A and the node with the node ID “001” connected with the leaf switch E can communicate with each other via any one of the crossbar switches A2 to P2 on the third switch stage.

It should be noted that such communications as shown in FIG. 18 can be performed in the same manner in an N-stage fat tree with N being 1 or more.

Next shown below is an example of performing the data exchanges between adjacent nodes within the 3-dimensional rectangular area by using the 3-stage fat tree shown in FIG. 18.

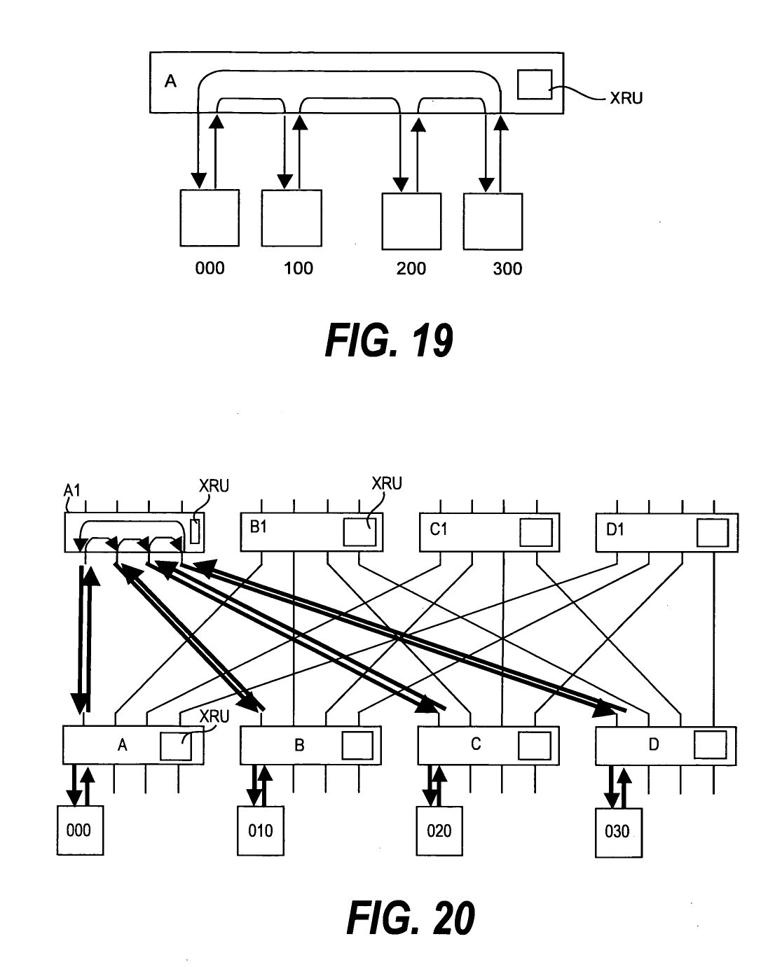

FIG. 19 shows an example of performing data transfers by the leaf switch A in the X-axis direction. It should be noted that the routing unit XRU of each crossbar switch holds the connection information shown in FIG. 18.

In the data transfers in the X-axis direction, the nodes of interest have the node IDs whose first and second digits are respectively the same and whose third digits are different, so the leaf switch A folds back the data transfer route on the switch itself on the first stage. In this example, similarly to FIG. 9, the data transfer toward the negative direction cannot be executed after the data transfer toward the positive direction has been completed.

FIG. 20 illustrates the data transfers in the Y-axis direction, and the nodes of interest have the node IDs whose second digits are different, so the routing units XRU of the leaf switches A to D on the first stage transfer packets to the crossbar switches A1 to D1 on the second switch stage. Further, the nodes of interest have the node IDs whose first digits are the same, so the routing units XRU of the crossbar switches A1 to D1 on the second stage folds back the data transfer route to the leaf switches A to D.

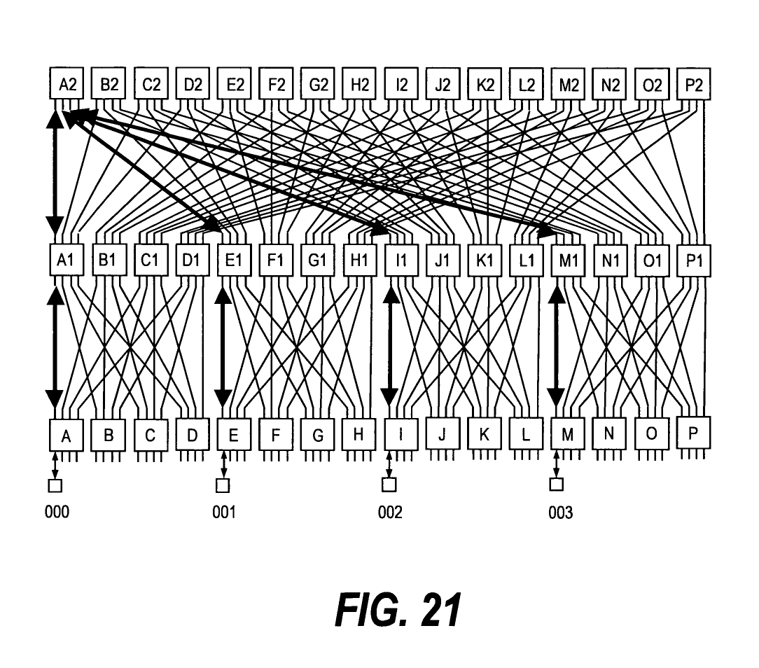

FIG. 21 illustrates the data transfers in the Z-axis direction, and the node ID contained in the packet of interest as the transmission destination ID has the first digit different from that of the transmission source ID, so the crossbar switches on the first and second stages transfer the packet to the crossbar switch A2 on the third stage, and further transfers the packet to the second stage and then to the first stage in order.

The data transfers between adjacent nodes within the 3-stage fat tree in the X-, Y-, and Z-axis directions are performed as described above with reference to FIGS. 19 to 21, and the completion of such data exchanges toward the positive and negative directions of the respective axes as indicated by the source codes (1) to (6) of FIG. 15 requires a time 6T that is 6 times as long as the time “1T” required for the data exchange in the 3-dimensional torus.

### (3-Stage Fat Tree+Mesh Coupling)

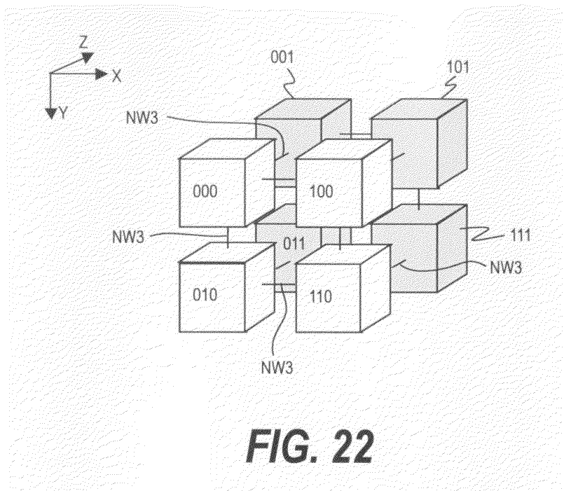

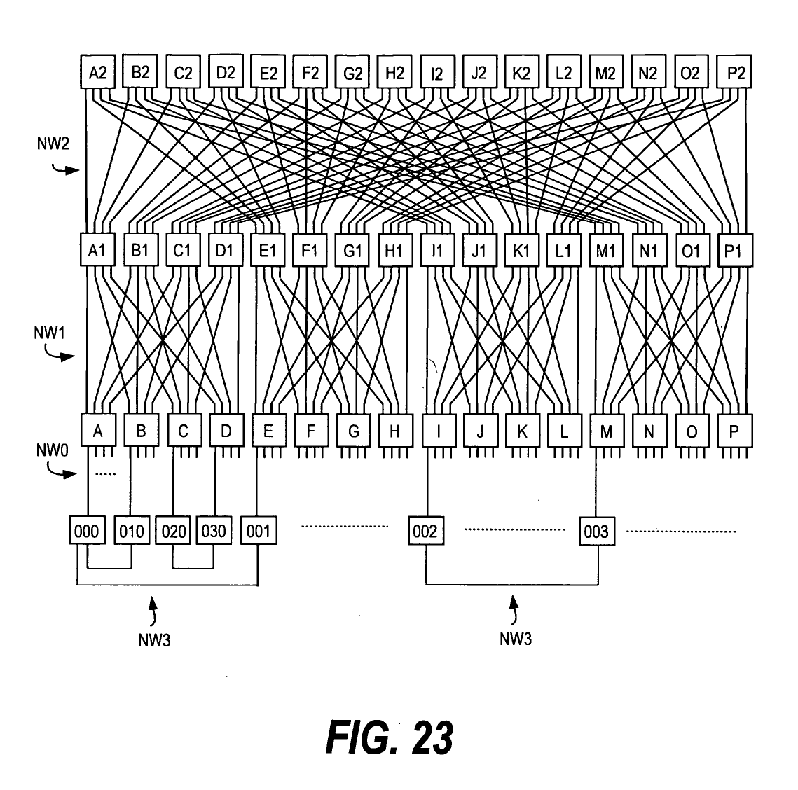

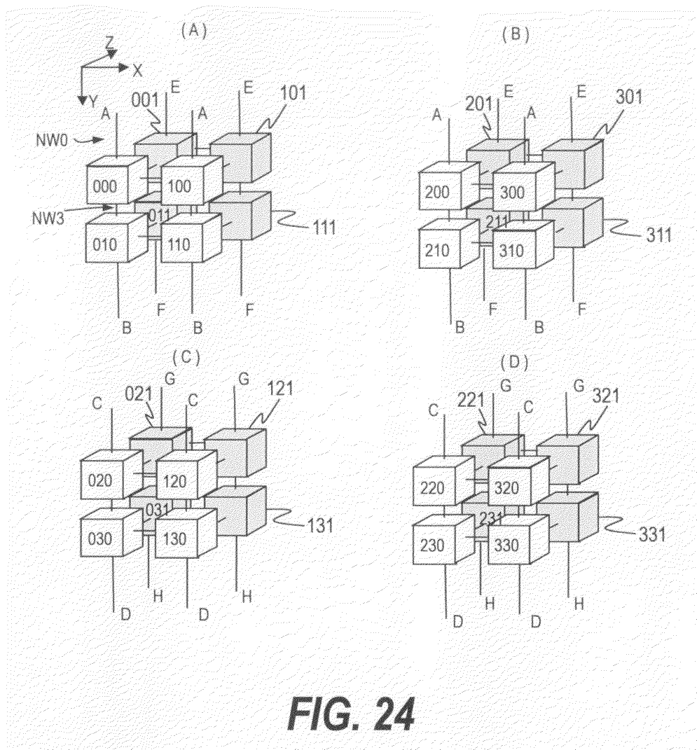

FIGS. 22 to 23 and 24A to 24D are block diagrams showing a configuration of the second embodiment of this invention. FIG. 22 is the block diagram showing connections between nodes, FIG. 23 is the block diagram showing the 3-stage fat tree and connections between nodes, and FIGS. 24A to 24D are the block diagrams showing connections between nodes and the leaf switches.

In the second embodiment, nodes that are arranged in the 3-dimensional rectangular area shown in FIG. 16 and in the 3-stage fat tree of FIG. 1 are connected with the leaf switches in the connection relationships indicated in FIG. 18, and similarly to the first embodiment, the nodes adjacent to each other in the Y-axis direction and the nodes adjacent to each other in the Z-axis direction are respectively connected directly by the partial networks NW3. The connection along the X-axis direction is the same as that of the first embodiment shown in FIG. 10.

In FIG. 23, the leaf switches A to P are each connected with corresponding nodes by the networks NW0 according to FIG. 18. The relationship between the nodes within the 3-dimensional rectangular area is the same as that of FIG. 16.

In addition, mesh coupling is effected by directly connecting the nodes adjacent to each other in each of the X-axis direction, the Y-axis direction, and the Z-axis direction within the 3-dimensional rectangular area shown in FIG. 16 by the partial network NW3 as shown in FIG. 22.

Among the nodes coupled by the partial networks NW3, only the nodes belonging to outer faces are connected with the leaf switches A to P in the fat tree. The term “outer faces” used herein refers to nodes each of which does not have 6 links with respect to other nodes (excluding a link with respect to the leaf switch) in the case of a 3-dimensional mesh. In the second embodiment, due to the 2×2×2 mesh coupling, all of the nodes belong to the outer faces, and are therefore connected with the leaf switches.

In FIG. 22, for example, the node having the node ID “000”, which is in FIG. 16 adjacent to the node having the node ID “100” in the X-axis direction, adjacent to the node having the node ID “010” in the Y-axis direction, and adjacent to the node having the node ID “001” in the Z-axis direction, is connected directly to those adjacent nodes by the partial networks NW3, and the nodes belonging to the outer faces in the mesh coupling (all of the nodes in the second embodiment) are connected with the leaf switches A to P based on the connection relationship of FIG. 18.

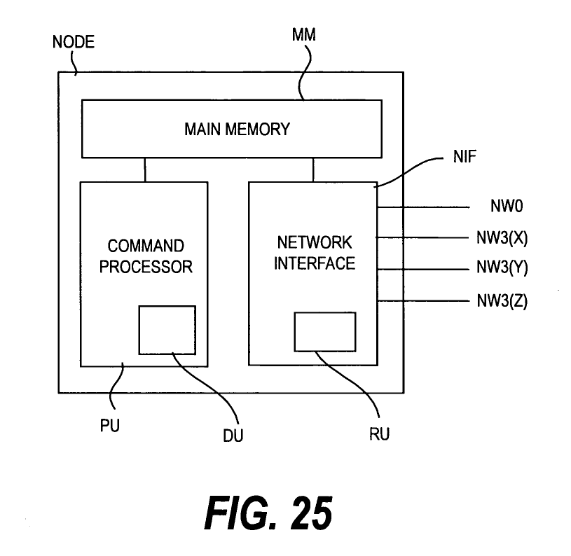

As shown in FIG. 25, the network interface NIF of each of the nodes belonging to the outer faces in the mesh coupling has links to the network NW0 for connection with the leaf switch, the partial network NW3 (X) for connection between nodes adjacent in the X-axis direction, the partial network NW3 (Y) for connection between nodes adjacent in the Y-axis direction, and the partial network NW3 (Z) for connection between nodes adjacent in the Z-axis direction. The routing unit RU references the ID of a packet transmission destination node to send out the packet to any one of the partial network NW3 (X), the partial network NW3 (Y), and the partial network NW3 (Z) if the node is directly connected with the transmission destination node, and otherwise send out the packet to the network NW0. In other respects, the configuration of the second embodiment is the same as that of the first embodiment shown in FIG. 11.

As shown in FIGS. 24A to 24D, with the nodes classified into 4 groups in terms of the leaf switches A to P on the first stage as shown in FIG. 18, the partial network NW3 between the nodes in the Y-axis direction effects a connection within the group, and the partial network NW3 between the nodes in the Z-axis direction effects a connection between the adjacent groups.

For example, in FIG. 24A, the node having the node ID “000” is connected in the Y-axis direction with the adjacent node having the node ID “010” within the same group, and connected in the Z-axis direction with the node having the node ID “001” belonging to the adjacent group.

In other words, the following connection rules indicated in the first embodiment:
the adjacent 2 nodes form a pair, and the partial network NW3 for directly connecting only the nodes forming the pair is provided; and
however, each node belongs to only one pair, and does not belong to another pair simultaneously,
   are applied inside and outside the group of the leaf switches.

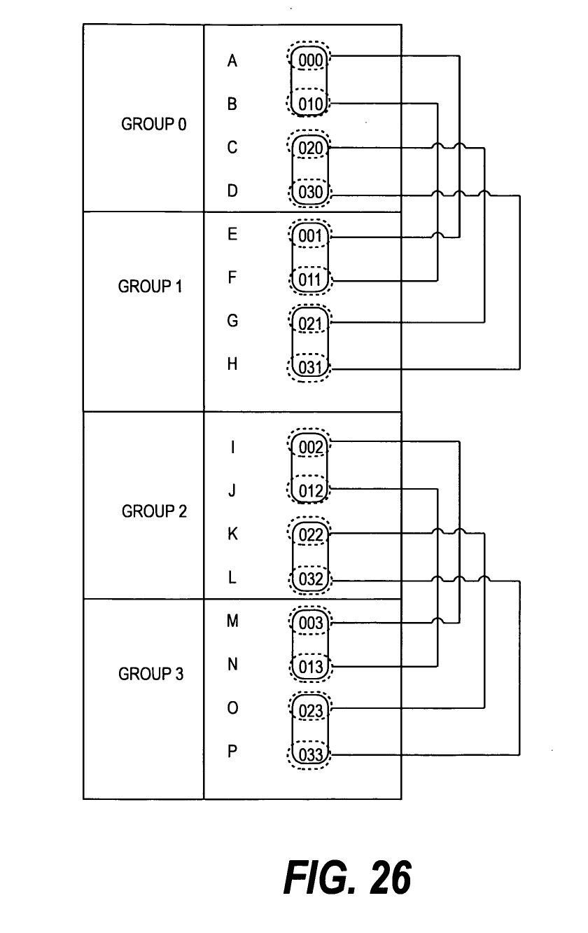

In the case where the leaf switches A to P are classified into 4 switch groups (Groups 0 to 3), the partial networks NW3 connecting the nodes, which head the lists of nodes connected with the leaf switches A to P as shown in FIG. 18, in the Y-axis direction and the Z-axis direction are shown in FIG. 26.

To be specific, as shown in FIG. 26, the partial networks NW3 connect the nodes heading the lists of nodes connected with the leaf switches A to P in the Y-axis direction in pairs each, surrounded by the ellipse, and in the Z-axis direction between pairs indicated by the solid line. It should be noted that the same applies to the other nodes connected with the leaf switches A to P.

In the Y-axis direction, the adjacent 2 nodes form a pair within the same switch group, each node belongs to only one pair and does not belong to another pair simultaneously, and the partial network NW3 for directly connecting only the nodes forming the pair is provided.

In the Z-axis direction, the nodes form a pair across the adjacent 2 switch groups, each node belongs to only one pair and does not belong to another pair simultaneously, and the partial network NW3 for directly connecting only the nodes forming the pair is provided. The nodes forming the pair in the Z-axis direction have the node IDs whose second and third digits are respectively the same.

Hereinafter, description will be made of data exchanges between adjacent nodes within the 3-dimensional rectangular area in the case of combining the 3-stage fat tree with the mesh coupling as described above.

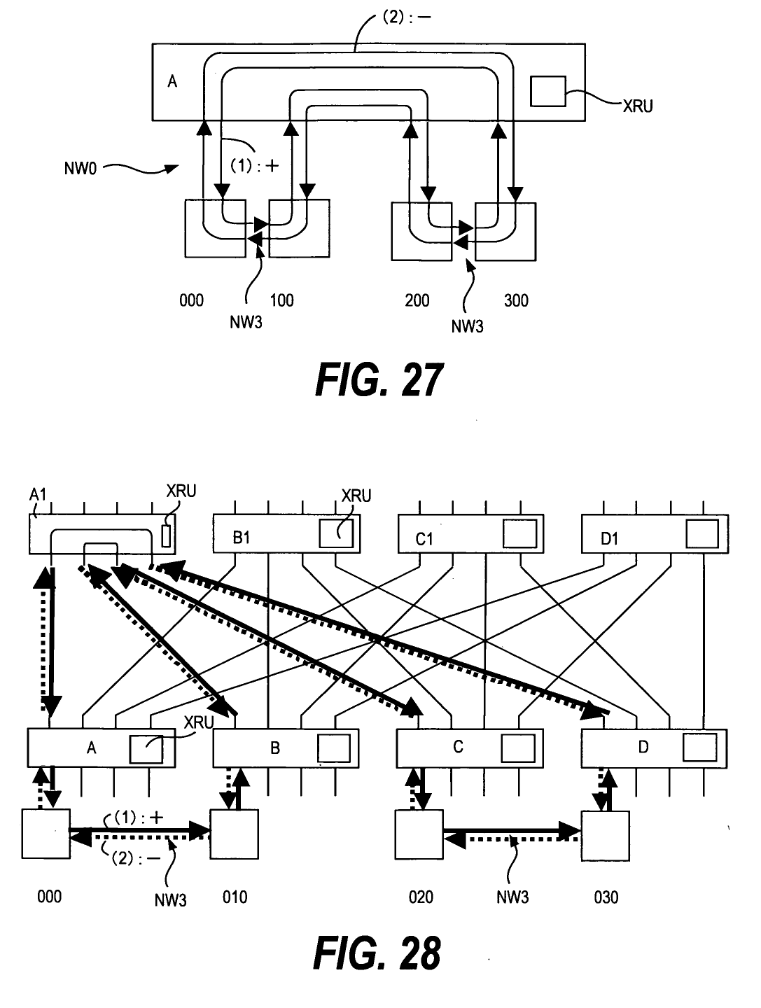

First, as shown in FIG. 27, similarly to the first embodiment, in the data exchanges between adjacent nodes in the X-axis direction, the adjacent nodes forming a pair perform the two-way communications by the partial network NW3, and each of the nodes performs the two-way communications with the leaf switch by the network NW0, thereby making it possible to perform the data transfer toward the positive direction indicated by (1) in FIG. 27 and the data transfer toward the negative direction indicated by (2) simultaneously, and to set a time required for the data exchange between adjacent nodes in the X-axis direction as “1T”.

The routing unit XRU operates similarly to that of the normal 3-stage fat tree. To be specific, in FIG. 27, the transmission destination node ID and the transmission source node ID of the packet are the same in the first and second digits and differ in the third digit, so the packet transmission route is folded back at the leaf switch.

FIG. 28 shows data exchanges between adjacent nodes in the Y-axis direction. In FIG. 28, within the fat tree, the transmission destination node ID and the transmission source node ID of the packet differ in the second digit and are the same in the first digit, so the packet transmission route is folded back at the crossbar switch on the second stage similarly to FIG. 20. Further, the two-way communications are performed by the nodes in a pair across the adjacent switches (in FIG. 28, “000” and “010”, and “020” and “030”) by the partial network NW3 provided therebetween, thereby making it possible to perform the data transfer toward the positive direction indicated by (1) in FIG. 28 and the data transfer toward the negative direction indicated by (2) simultaneously, and to set a time required for the data exchange between adjacent nodes in the Y-axis direction as “1T”.

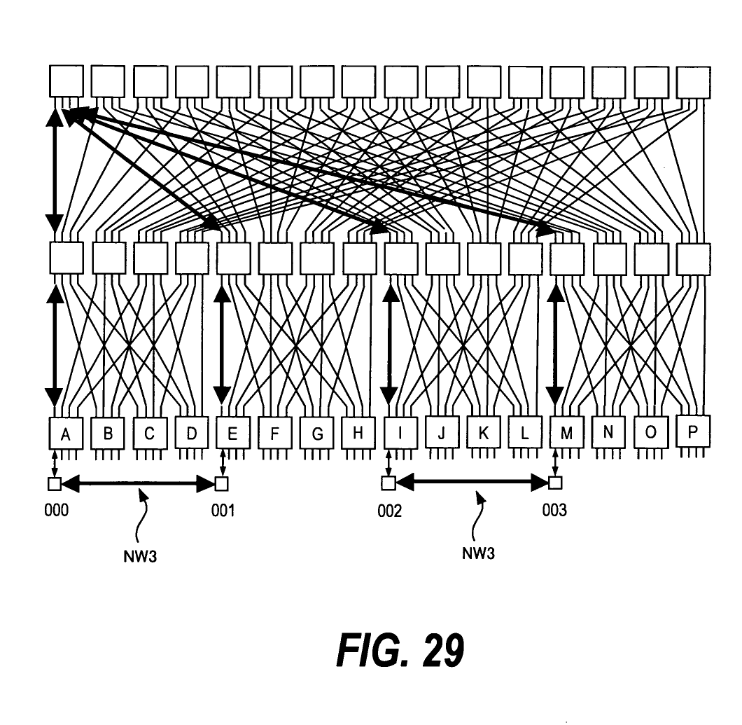

FIG. 29 shows data exchanges between adjacent nodes in the Z-axis direction. In FIG. 29, within the fat tree, the transmission destination node ID and the transmission source node ID of the packet differ in the first digit, so the packet transmission route is folded back at the crossbar switch on the third stage similarly to FIG. 21. Further, the two-way communications are performed by the nodes in a pair across the adjacent switch groups (in FIG. 29, “000” and “001”, and “002” and “003”) by the partial network NW3 provided therebetween, thereby making it possible to perform the data transfer toward the positive direction and the data transfer toward the negative direction simultaneously, and to set a time required for the data exchange between adjacent nodes in the Z-axis direction as “1T”.

From the above description with reference to FIGS. 27 to 29, in the 3-dimensional rectangular area in which the 3-stage fat tree is added with the mesh coupling, the time required for the data exchange between adjacent nodes in the X-, Y-, and Z-axis directions is 1T per axis, and a twice larger bandwidth can be provided than the case (6T) of only the 3-stage fat tree shown in FIGS. 19 to 21.

In this case, even if the throughput of the partial network NW3 is ⅓ of the throughput of the network NW0 to NW2 of the fat tree, the data exchanges in the X-, Y-, and Z-axes can be processed for a time of 3T. This is because the adjacent communications in the X-axis direction ((1) and (2) of FIG. 15), the adjacent communications in the Y-axis direction ((3) and (4) of FIG. 15), and the adjacent communications in the Z-axis direction ((5) and (6) of FIG. 15) are sequentially executed via the fat tree, and at the same time, between the nodes subjected to the mesh coupling, the adjacent communications via the partial network NW3 can be simultaneously performed in the 6 directions of the positive and negative directions of the X, Y, the Z-axis directions. For example, in FIG. 24A, if the transfer speed of the network NW0 for connecting the node having the node ID “000” with the leaf switch A is set as 10 Gbps, the node having the node ID “000” can simultaneously communicate with the 3 nodes having the node IDs “100”, “010”, and “001” that are connected by the partial networks NW3, so approximately 3.3 Gbps is sufficient for the transfer speed of the partial network NW3.

According to the second embodiment, only by adding the partial network NW3 to the existing fat tree, a twice larger bandwidth than the conventional fat tree can be secured with ease in the case of data exchanges within the 3-dimensional rectangular area, and the bandwidth of the partial network NW3 can be made narrower than the bandwidth on the leaf switch side, which makes it possible to suppress the cost for the network interface NIF. Accordingly, in building a parallel computer system such as a supercomputer that uses a large number of nodes, it is possible to provide a computer system excellent in flexibility of operation and high in data transfer speed which uses the existing fat tree and employs the network interface NIF low in cost to suppress the equipment spending.

It is obvious that the above-mentioned operation is possible even by using a mesh coupling node group larger than 2×2×2 in which there exist nodes that do not belong to the outer faces of the mesh coupling.

### Third Embodiment

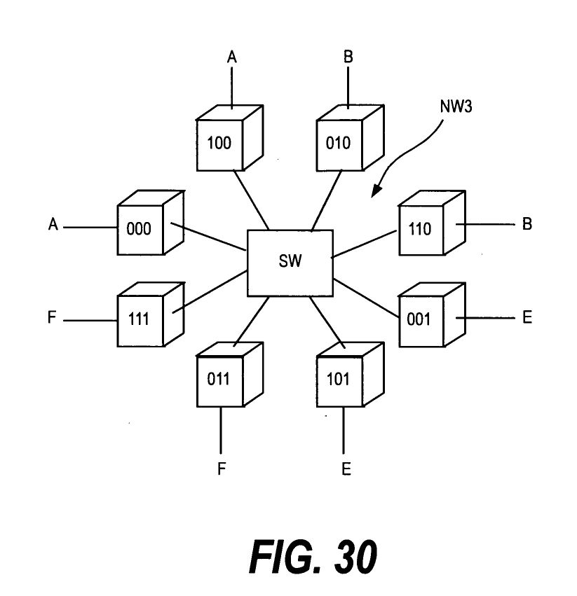

FIG. 30 shows a third embodiment, which is the same as the second embodiment except that the partial network NW3 of the second embodiment is replaced by a star topology switch.

The connection between each node and the leaf switch of the fat tree is the same as that of FIG. 18. Also in this case, similarly to the second embodiment, the data exchanges within the 3-dimensional rectangular area can be executed at higher speed than the conventional fat tree.

In this case, the adjacent communications in the X-axis direction, the adjacent communications in the Y-axis direction, and the adjacent communications in the Z-axis direction cannot be performed simultaneously within a node group. For example, the X-axis direction communications between the nodes having the node IDs “000” and “100” and the Y-axis direction communications between the nodes having the node IDs “000” and “010” cannot be performed simultaneously because a conflict occurs in the path between the node having the node ID “000” and the switch.

Accordingly, in order to obtain the same effects as the second embodiment, the throughput of the partial network NW3 needs to be the same as the throughput of the fat tree.

### Fourth Embodiment

The example of the 3-stage fat tree and the 3-dimensional mesh coupling nodes has been described in the second embodiment. It is obvious that the connections and operations may be applied to a case where a group of nodes connected by N-dimensional mesh coupling is connected with an M-stage fat tree (N is M or more).

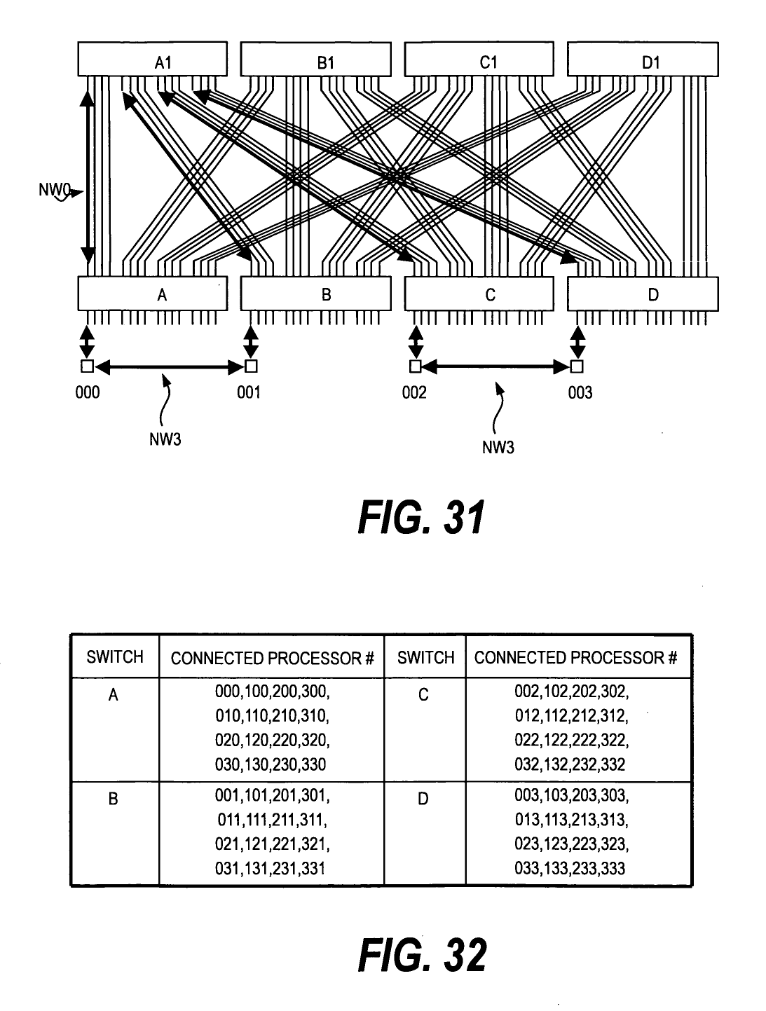

For example, the group of nodes connected by the partial networks NW3 of the 3-dimensional mesh shown in FIG. 22 may be connected with the 2-stage fat tree shown in FIG. 31. In this case, the connections between the leaf switches A to D and the nodes are indicated in FIG. 32.

The lower 2 stages of the 3-stage fat tree are reduced to 1 stage, so the nodes serialized in the X-axis direction and the Y-axis direction are connected to the same switch. In other words, all of the nodes that have node IDs whose third digits (hundred's digits) and second digits (ten's digits) are respectively different and whose first digits (one's digits) are the same are connected with the same switch.

Similarly to the second embodiment, the routing unit within the node may send out the packet to the fat tree side if the transmission destination node is not connected by the partial network NW3. It should be noted that in the data exchanges between adjacent nodes in the Z-axis positive direction, the packet sent out from the node having the node ID “000” is sent to the node having the node ID “001” via the partial network NW3. The packet sent from the node having the node ID “001” is sent to the node having the node ID “002” via the leaf switch B, the crossbar switch Al, and the leaf switch C. The packet sent out from the node having the node ID “002” is sent to the node having the node ID “003” via the partial network NW3. The packet sent from the node having the node ID “003” is sent to the node having the node ID “000” via the leaf switch D, the crossbar switch A1, and the leaf switch A, and thus circulates in the rectangular area. The data transfer in the reverse direction is also performed along the same route. Accordingly, even if the group of nodes connected by the N-dimensional mesh coupling is connected with the M-stage fat tree, the same effects as the second embodiment can be obtained.

As described above, the parallel computer system according to this invention can be applied to a supercomputer and a super parallel computer which include a large number of nodes.

While the present invention has been described in detail and pictorially in the accompanying drawings, the present invention is not limited to such detail but covers various obvious modifications and equivalent arrangements, which fall within the purview of the appended claims.

What is claimed is:

1. A parallel computer system, comprising:
a plurality of nodes each of which includes a processor and a communication unit;
a switch for connecting the plurality of nodes with each other;
a first network for connecting each of the plurality of nodes and the switch; and
a second network for partially connecting the plurality of nodes with each other.

2. The parallel computer system according to claim 1, wherein the first network is comprised of one of a fat tree and a multistage crossbar network.

3. The parallel computer system according to claim 1, wherein the second network partially connects predetermined nodes among the plurality of nodes directly with each other.

4. The parallel computer system according to claim 1, wherein the second network is comprised of an N-dimensional mesh network, in which N is 1 or more.

5. The parallel computer system according to claim 4, wherein:
the second network is comprised of a node group composed of a plurality of nodes that are coupled by the N-dimensional mesh network; and
the plurality of nodes within the node group include:
a first node having twice N links for coupling to another node within the node group; and
a second node having N links for coupling to another node within the node group, and further having a link for coupling to the first network.

6. The parallel computer system according to claim 3, wherein:
the plurality of nodes each include:
a communication packet generation unit for generating a packet for performing communications with one of the first network and the second network with an identifier of a transmission destination node contained in the packet; and
a routing unit for performing routing that sends out the packet based on the identifier of the transmission destination node contained in the packet; and
if the identifier of the transmission destination node indicates a node directly connected by the second network, the routing unit sends out the packet to the second network, and if the identifier of the transmission destination node indicates a node that is not directly connected by the second network, the routing unit sends out the packet to the first network.

7. The parallel computer system according to claim 3, wherein:
each of the plurality of nodes has a node identifier composed of M digits;
values of the digits each indicate a position of a node within the node group subjected to coupling by one of an M-dimensional mesh and an M-dimensional torus; and
the nodes having the node identifiers whose values of a specific digit are different are connected with a combination of switches mutually communicable on the same switch stage of the first network.

8. The parallel computer system according to claim 1, wherein:
the first network includes a switch for connection with at least one of the plurality of nodes; and
the second network forms a pair of adjacent 2 nodes among the plurality of nodes that are connected with the switch, and directly connects only the nodes forming the pair.

9. The parallel computer system according to claim 8, wherein the second network causes each of the plurality of nodes forming the pair to belong to only one pair and not to belong to another pair simultaneously.

10. The parallel computer system according to claim 1, wherein:
the first network includes:
a first switch for connection with at least one of the plurality of nodes; and
a second switch for connecting a plurality of the first switches; and
the second network forms a pair of adjacent 2 nodes among the plurality of nodes that are connected with the first switch, causes each of the plurality of nodes to belong to only one pair, and directly connects only the nodes forming the pair.

11. The parallel computer system according to claim 1, wherein:
the first network includes:
a first switch for connection with at least one of the plurality of nodes; and
a second switch for connecting a plurality of the first switches; and
the second network forms, via the second switch, a pair of nodes across two of the first switches adjacent to each other, causes each of the plurality of nodes to belong to only one pair, and directly connects only the nodes forming the pair.
